(19) United States
(12) Patent Application Publication
(10) Pub. No.: US 2025/0300715 A1
(43) Pub. Date: Sep. 25, 2025

(54) APPARATUS AND METHOD FOR MULTI-ANTENNA BASED BEAMFORMING IN A WIRELESS COMMUNICATION SYSTEM

(71) Applicant: ELECTRONICS AND TELECOMMUNICATIONS RESEARCH INSTITUTE, Daejeon (KR)

(72) Inventors: Chanho YOON, Daejeon (KR); Jung Ho MYUNG, Daejeon (KR); Young Jo KO, Daejeon (KR); Wooram SHIN, Daejeon (KR); Woncheol CHO, Daejeon (KR)

(73) Assignee: ELECTRONICS AND TELECOMMUNICATIONS RESEARCH INSTITUTE, Daejeon (KR)

(21) Appl. No.: 19/078,605

(22) Filed: Mar. 13, 2025

(30) Foreign Application Priority Data
Mar. 19, 2024 (KR) 10-2024-0037877
Feb. 6, 2025 (KR) 10-2025-0014933

(51) Int. Cl. H04B 7/06; H01Q 1/24; H01Q 1/52; H04B 17/318; H04L 5/00

(52) U.S. Cl. CPC H04B 7/0695; H01Q 1/246; H01Q 1/523; H04B 17/328; H04L 5/0051

(57) ABSTRACT

The present disclosure generally relates to wireless communication systems, and more specifically to an apparatus and method for multi-antenna based beamforming in wireless communication systems. A method for operating a terminal in a wireless communication system may include: receiving synchronization signal blocks (SSBs) transmitted from multiple beam groups in a common frequency region; selecting an optimal beam group based on measuring signal strength of the SSBs; receiving reference signals based on a subchannel allocated to the optimal beam group; and performing beam tracking based on the reference signals.

### CROSS REFERENCE TO RELATED APPLICATION

The present application claims priority to Korean Patent Application No. 10-2024-0037877, filed on Mar. 19, 2024, and Korean Patent Application No. 10-2025-0014933, filed on Feb. 6, 2025, the entire contents of which are incorporated herein for all purposes by this reference.

### BACKGROUND

### Technical Field

The present disclosure generally relates to wireless communication systems, and more particularly to an apparatus and method for multi-antenna based beamforming in wireless communication systems.

### Description of the Related Art

The evolution of each generation of wireless communication technology, including 4G Long Term Evolution (LTE) and 5G New Radio (NR), has aimed to surpass the requirements of previous generations. For example, one goal of 5G NR was to achieve twenty times the maximum transmission rate and capacity of 4G LTE. To achieve this, cellular system capacity was enhanced through the utilization of new frequency bands such as 3.5 GHz center frequency, allocation of wide bandwidths, and the application of massive Multiple Input and Multiple Output (MIMO) with multiple antennas, multiple transmission and reception radio frequency (RF) chains, and multiple spatial layers. Additionally, this was achieved through the application of beamforming (BF) in Time Division Duplexing (TDD) systems, considering the channel characteristics and wide bandwidth of the 28 GHz millimeter wave (mmWave) band.

For 6G cellular networks, the goal is to achieve twenty times higher maximum capacity/transmission rate compared to 5G NR. Similar to NR's approach, this aims to be achieved by utilizing new frequency ranges and applying extreme massive MIMO (emMIMO) with wider bandwidth, more antennas, RF chains, and layers. The existing NR frequency bands are divided into two ranges: Frequency Range 1 (FR1) below 6 GHz and Frequency Range 2 (FR2) above 6 GHz. FR1 is mainly deployed in urban cell environments, while FR2 has practical limitations due to severe path loss and frequency-dependent indoor penetration loss, particularly through materials like concrete, making it primarily suitable for indoor hotspot environments. When FR2 base stations (or next Generation Node B: gNB) are deployed in common outdoor environments (e.g., urban rooftops), the indoor signal strength through concrete shows nearly 50 dB more attenuation compared to FRI bands, necessitating base stations capable of achieving high beamforming gain for compensation.

While the reduction in cell coverage radius due to increased path loss in higher frequency bands can be compensated through densification, such as installing more base stations, this approach leads to increased interference from adjacent cells and higher operating costs for service providers. Therefore, 6G aims to introduce the upper middle band (7-20 GHz: FR3) for urban cell applications while reusing existing LTE and NR base station locations.

The intensified path loss and indoor penetration loss in the relatively high FR3 frequency band compared to FRI presents a significant challenge in achieving the target of twenty times higher cell capacity compared to NR. To overcome path and penetration losses in the FR3 band and increase cell capacity, emMIMO is likely to be implemented. With emMIMO, up to 1024 antenna elements (AE) can be utilized, enabling sufficient beamforming gain to overcome attenuation. Additionally, within the FR3 range, lower frequency bands such as 7 GHz show significantly improved signal attenuation compared to FR2, allowing for similar or slightly reduced cell coverage when installed at existing base station locations. However, when a very large number of AEs are applied, the base station's transmitted beam becomes very sharp/narrow, reducing the probability of beam alignment between the base station and terminals. Conversely, reducing the number of AEs results in wider beams but lower beamforming gain. Consequently, the probability of multiple terminals aligning within a single narrow beam also decreases, increasing the likelihood of coverage holes where beam alignment fails. This can lead to complexity issues in managing numerous detailed beam profiles.

When beams are narrow, there are several disadvantages: the spatial area and steps required for beam sweeping in the time domain increase, leading to substantial beam alignment delays with terminals, and the narrow beam itself may become narrower than the actual channel spread. Additionally, the application of numerous AEs and RF chains can result in high energy consumption.

However, to achieve higher capacity and comparable cell coverage compared to NR, implementing emMIMO with many AEs is considered practical, as it would be difficult to achieve solely through increased signal bandwidth in the FR3 band. Therefore, it is necessary to propose an emMIMO operation method and resource management scheme that can maintain wide cell coverage while minimizing beam sweeping delay and overcoming blockage and limited diffraction effects that are more prominent in the FR3 band. In particular, there is a need for a system architecture that minimizes power consumption for reference signal processing during initial access from the terminal's perspective and enables detection while minimizing energy consumption during transmission to the base station.

Furthermore, since base station cells need to simultaneously exchange uplink and downlink data with multiple terminals, parallel beam management control must be applied. In conventional systems, multiple terminals could be multiplexed simultaneously in frequency or spatial domains only when beams were aligned with the terminals. That is, beam alignment between the base station and terminals was a prerequisite, but when the number of terminals and antennas is large, the optimal number of beam variations increases exponentially. Therefore, while forming narrow beams with many antennas is important, it is also efficient to maintain connectivity with multiple terminals within a single beam pattern by forming broad beams. A specific systematic approach for this needs to be presented in emMIMO systems with numerous antennas.

### SUMMARY

Based on the above discussion, the present disclosure provides an apparatus and method for providing wide beam coverage while avoiding interference between beams by grouping multiple antenna elements in a wireless communication system.

Additionally, the present disclosure provides an apparatus and method for performing parallel beam management for multiple terminals by allocating subchannels for each beam group in a wireless communication system.

Furthermore, the present disclosure provides an apparatus and method for transmitting synchronization signal blocks to enable energy-efficient beam detection during initial terminal access in a wireless communication system.

Moreover, the present disclosure provides an apparatus and method for performing efficient CSI-RS-based beam tracking within beam groups in a wireless communication system.

Additionally, the present disclosure provides an apparatus and method for managing handover between adjacent beam groups to support terminal mobility in a wireless communication system.

According to various embodiments of the present disclosure, a method for operating a terminal in a wireless communication system includes receiving a synchronization signal block (SSB) transmitted from multiple beam groups in a common frequency region; selecting an optimal beam group based on measuring the signal strength of the SSB; receiving a reference signal based on a subchannel allocated to the optimal beam group; and performing beam tracking based on the reference signal.

According to various embodiments of the present disclosure, a terminal in a wireless communication system includes a transceiver and a controller operably connected to the transceiver. The controller is configured to receive a synchronization signal block (SSB) transmitted from multiple beam groups in a common frequency region; select an optimal beam group based on measuring the signal strength of the SSB; receive a reference signal based on a subchannel allocated to the optimal beam group; and perform beam tracking based on the reference signal.

According to various embodiments of the present disclosure, a method for operating a base station in a wireless communication system includes: grouping multiple antenna elements into multiple beam groups; allocating different subchannels to each of the multiple beam groups; cyclically changing the different subchannels over time to enable the multiple beam groups to transmit synchronization signal blocks (SSB) in a common frequency region; and performing beam tracking by transmitting reference signals within each beam group.

According to various embodiments of the present disclosure, a base station in a wireless communication system includes a transceiver and a controller operably connected to the transceiver. The controller is configured to: group multiple antenna elements into multiple beam groups; allocate different subchannels to each of the multiple beam groups; cyclically change the different subchannels over time to enable the multiple beam groups to transmit synchronization signal blocks (SSB) in a common frequency region; and perform beam tracking by transmitting reference signals within each beam group.

According to various embodiments of the present disclosure, the apparatus and method enable parallel data transmission to multiple terminals without interference by configuring large numbers of antennas into beam groups and allocating resources based on subchannels.

Additionally, the apparatus and method of the present disclosure enable energy-efficient beam management for terminal initial access and mobility support by sequentially transmitting synchronization signals in a common frequency region and performing CSI-RS (Channel State Information-Reference Signal) based tracking per beam group.

Furthermore, the apparatus and method of the present disclosure enable efficient power consumption management of the system by minimizing the power of beam groups not communicating with terminals.

Moreover, the apparatus and method of the present disclosure enable achievement of high transmission rates and capacity required in 6G systems by effectively overcoming path loss and penetration loss in the FR3 band.

The effects of the present disclosure are not limited to those mentioned above, and other unmentioned effects will be clearly understood by those skilled in the art from the following detailed description.

### BRIEF DESCRIPTION OF THE DRAWINGS

FIG. 1 illustrates a cell base station site deployment structure according to an embodiment of the present disclosure.

FIG. 2 illustrates a mapping structure between beam groups and subchannels according to an embodiment of the present disclosure.

FIG. 3 illustrates a configuration of RF units and baseband equipment of a base station according to an embodiment of the present disclosure.

FIG. 4 illustrates an example of variable physical size operation of beam groups according to an embodiment of the present disclosure.

FIG. 5 illustrates a periodic permutation mapping structure between beam groups and subchannels according to an embodiment of the present disclosure.

FIG. 6 illustrates a random access procedure for terminal initial access according to an embodiment of the present disclosure.

FIG. 7 illustrates a method of terminal operation according to an embodiment of the present disclosure.

FIG. 8 illustrates a method of base station operation according to an embodiment of the present disclosure.

FIG. 9 illustrates a configuration of a base station in a wireless communication system according to various embodiments of the present disclosure.

FIG. 10 illustrates a configuration of a terminal in a wireless communication system according to various embodiments of the present disclosure.

### DETAILED DESCRIPTION OF THE DISCLOSURE

The terms used in the present disclosure are selected from commonly used terms in consideration of their functions in the present disclosure, but may vary according to the intentions of those skilled in the art, practices, or the introduction of new technology. In some cases, terms specifically selected by the applicant may also be used. In such cases, their meaning will be clearly described in the corresponding description section of the disclosure. Therefore, the terms used in the present disclosure should be understood not simply by their literal meanings but by their meaning within the context of the present disclosure.

The use of singular expressions in the present disclosure includes plural expressions unless explicitly stated otherwise in the context. The term “include” or “comprise” used in the description and claims should be understood as specifying the presence of features, numbers, steps, operations, components, elements, or combinations thereof that are described in the specification, and should not be construed as excluding the possibility of the presence or addition of one or more other features, numbers, steps, operations, components, elements, or combinations thereof.

Terms including ordinal numbers such as “first,” “second,” etc., used in the present disclosure may be used to describe various components, but the components should not be limited by these terms. These terms are only used to distinguish one component from another component. For example, a first component could be termed a second component without departing from the scope of the present disclosure, and similarly, a second component could be termed a first component.

For any examples where a specific detailed implementation is required to support the embodiments described in the present disclosure, descriptions corresponding to such implementations may be provided. However, those skilled in the art will appreciate that any variations and equivalents of such implementations may be used as alternatives without departing from the technical spirit of the present disclosure.

In the following description, well-known functions or constructions may not be described in detail to avoid obscuring the present disclosure with unnecessary detail. The description provided below is intended to assist in a comprehensive understanding of the embodiments of the present disclosure. The present disclosure may be carried out in other specific ways than those set forth herein without departing from the spirit and essential characteristics of the present disclosure.

### 1) Configuration and Designation Method for Transmission Ports and Subchannels Based on Group Beamforming in Extreme Massive MIMO Base Stations

1a. Multi-Beamforming Group Designation and Port-Wise Antenna Grouping Method

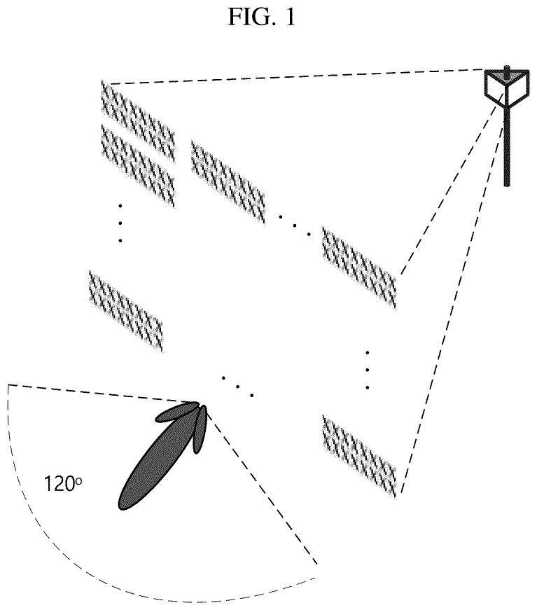

FIG. 1 illustrates a deployment structure of base station sites within a cell according to an embodiment of the present disclosure.

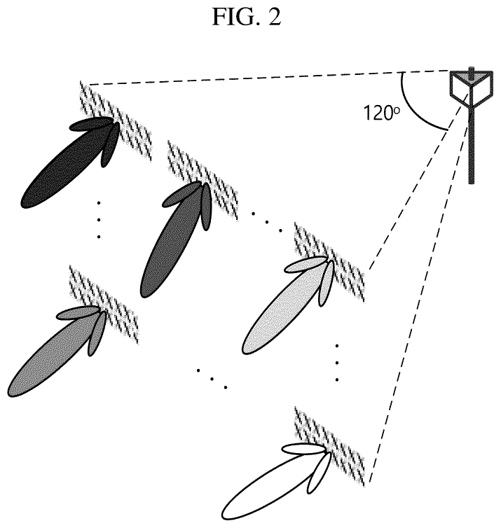

FIG. 2 illustrates a mapping structure between beam groups and subchannels according to an embodiment of the present disclosure.

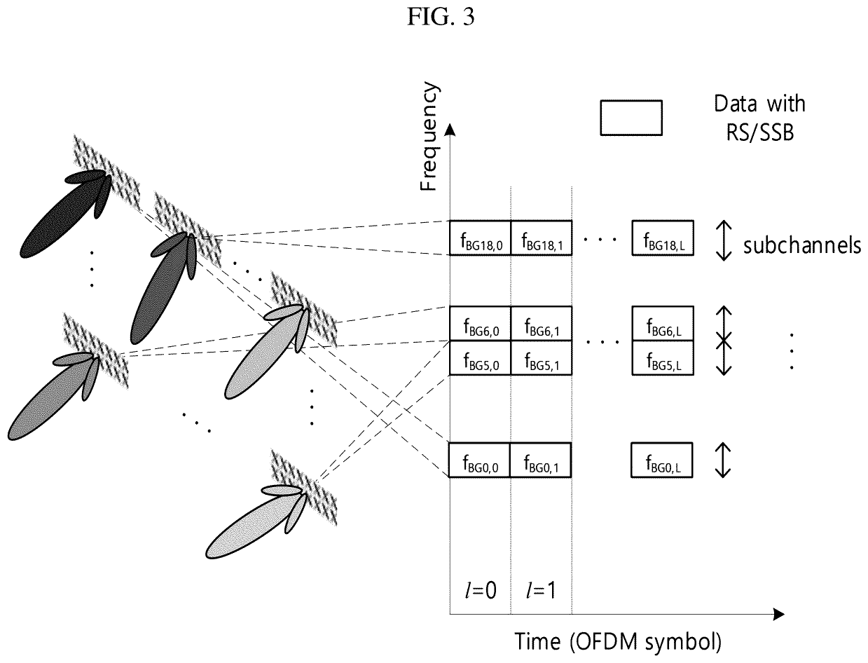

FIG. 3 illustrates a configuration of RF units and baseband equipment of a base station according to an embodiment of the present disclosure.

Referring to FIG. 1, the base station deployment can be based on a base station site covering a 120-degree azimuth angle within one cell. Here, it can be assumed that three sites are installed on outdoor rooftops to cover one cell.

Referring to FIG. 2, conventional massive MIMO systems adopted a method of forming and transmitting beams using all antennas. In contrast, the basic configuration proposed in this disclosure adopts a structure that forms wider beams by configuring independent beam groups without connecting all antennas at the site, as shown in FIG. 2. Each beam group can form beams targeting designated spaces that either do not overlap or partially overlap in three-dimensional spatial regions.

Each beam group in FIG. 2 can be mapped to different subchannels. The antenna elements of each beam group can be adjacently positioned and form a physical group. Each beam group can independently perform beamforming to form wide beam widths. At this time, interference between beam groups can be prevented through subchannel separation.

Referring to FIG. 3, for system implementation according to this disclosure, the base station can include 1024 antennas, 512 (or 256) RF chains, and 64 spatial layers. As shown in FIG. 3, the base station can include RF units and baseband equipment with digital beamforming and hybrid beamforming configurations.

Specifically, FIG. 3 shows in detail the RF chain configuration for digital beamforming and hybrid beamforming. It illustrates how 1024 antenna elements are connected to 512 (or 256) RF chains and how 64 spatial layers are implemented. Additionally, FIG. 3 shows the interface between the baseband processing unit and RF units.

When beamforming is performed using all antennas installed at the base station, a large transmission gain can be obtained, but the beam width becomes very narrow. Therefore, to cover the entire cell area through sweeping, the number of beams (horizontal or vertical angles) that need to be aligned becomes very large. When performing such beam sweeping operations and tracking, the delay in achieving beam alignment between the base station and terminals increases with the number of configured beams, and the corresponding resource overhead also increases.

To solve these problems, this disclosure implements a method that either applies fixed (relatively wide) beams targeting specific three-dimensional spatial regions by grouping multiple antennas and ports, or performs beamforming within limited azimuth and elevation angles within the beam group region. In this case, the corresponding spatial region occupies only subchannel frequency resources.

In one embodiment of the present invention, one spatial layer (port) can be physically connected or mapped to 16 antennas and 8 (or 4) RF chains uniformly, or can be mapped non-uniformly. A beam group can consist of physically adjacent antenna elements. As shown in FIG. 2, this disclosure can configure antenna elements, ports, and subchannels centered around beam groups.

According to one embodiment, this disclosure can assume a basic structure where one beam group is mapped to 2 spatial layers (ports) and one subchannel. In this structure, one spatial layer can be mapped to 16 antenna elements. Also, when the system's total downlink bandwidth is divided into subchannels, it can be divided into 32 narrow bands, resulting in the formation of 32 beam groups. All these configurations can be set in radio resource control (RRC) and broadcast to terminals.

1b. Method for Uniform Port and Subchannel Designation Per Beam Group

According to one embodiment of the present disclosure, a method for uniform port and subchannel designation per beam group can be provided.

Since the basic structure of this disclosure performs beam management for terminals grouped by multiple beam groups, the number of ports and subchannels that can be designated per beam group can be configured in various ways.

According to one embodiment, the total number of subchannels can be equal to the number of beam groups. The bandwidth of each subchannel can be determined by dividing the total system bandwidth by the total number of subchannels. Additionally, the base station can uniformly designate the total number of ports and subchannels corresponding per beam group.

In one embodiment of this disclosure, as shown in FIG. 3, when the total number of ports is 64, they can be uniformly mapped to 2, 4, 8, 16, 32, or 64 spatial layers per beam group. In this case, the system can use 1, 2, 4, 8, 16, or 32 subchannels per beam group in the downlink channel.

Here, when the total number of beam groups is N_{BG} and the number of spatial layers per beam group is N_{BG}^{L}, they can satisfy the relationship N_{BG}×N_{BG}^{L}=64.

1c. Method for Distributing Downlink Resources with Non-Uniform Multiple Spatial Layers and Subchannels Per Beam Group

According to one embodiment of the present disclosure, a method for non-uniform port and subchannel allocation per beam group can be provided.

In real wireless environments, various wireless channel conditions, terminal azimuth angles, elevation angle-related deployment positions, and frequency or time resource conditions may not be uniform. Particularly, when terminals are concentrated in specific spatial regions resulting in asymmetric spatial distribution, the number of ports and subchannels per beam group can be allocated non-uniformly. In this case, the total number of beam groups (N_{BG}) can have any value that is not necessarily a power of 2, and one beam group can occupy multiple subchannels. When the number of subchannels per beam group is denoted as N_{BG}^{SC}, N_{BG}^{SC} can have a value greater than 1.

According to one embodiment, a case can be considered where multiple terminals are concentrated in a specific spatial region while other regions have fewer terminals. In this case, a common beam group can be designated for the space where multiple terminals are located, allocating multiple ports (e.g., N_{BG}^{L}=16) and multiple subchannels (e.g., N_{BG}^{SC}=8). In contrast, for terminals in the remaining regions, a smaller number of ports (e.g., N_{BG}^{L}=2) and subchannels (e.g., N_{BG}^{SC}=1) can be allocated per beam group. Additionally, if no terminals exist in the spatial region of a specific beam group, the base station can switch that beam group to an idle state.

In one embodiment of this disclosure, the base station can flexibly distribute downlink transmission resources based on the number of ports and subchannels allocated to one beam group. For example, when multiple terminals within a beam group are quasi co-located or when the channel conditions are static with high channel scattering, multi-user MIMO can be applied by allocating multiple ports and spatially separating them while using wideband subchannels commonly allocated to terminals. Conversely, in situations where terminals are quasi co-located or multi-user MIMO cannot be applied due to downlink channel correlation between terminals, downlink resources can be allocated by maintaining the same port mapping per terminal while separating subchannels between terminals.

Additionally, in one embodiment of the present invention, the increase in spatial layers or subchannel allocation per beam group and the mapping method can be changed in the baseband. However, when the basic beam group unit increases, changes in resources and number of ports within a unit (beam group) mapped with antenna elements are accompanied.

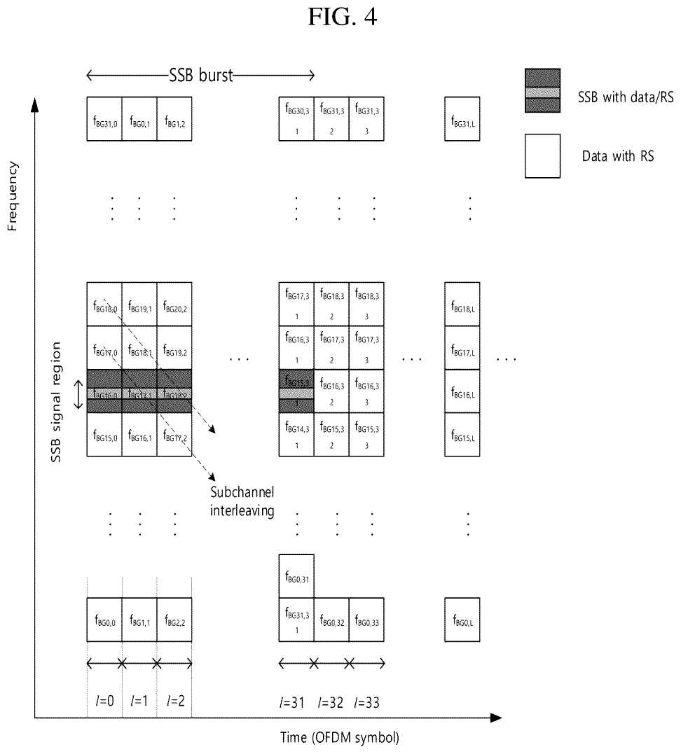

FIG. 4 illustrates an example of variable physical size operation of beam groups according to an embodiment of the present disclosure.

As shown in FIG. 4, when the terminal's downlink channel reception signal-to-noise ratio is low, the base station can change the physical size of the beam group based on feedback information transmitted by the terminal through the uplink. Such physical beam group mapping changes are possible when surrounding beam groups are in an idle state.

### 2) Method for Synchronization Signal Transmission Related to Group Beamforming for Terminal Initial Access

2a. Method for Synchronization Sequence Block Transmission for Initial Access

According to one embodiment of the present disclosure, this disclosure can provide an efficient synchronization signal transmission method for terminal initial access.

When frequency-distinguished beam groups independently transmit synchronization signals in their respective subchannel regions, problems may arise with increased energy consumption and delay as the frequency bandwidth that terminals need to process becomes wider. In particular, it may not be desirable in terms of energy efficiency for terminals operating with limited energy to perform beam sweeping across the entire downlink bandwidth.

To solve these problems, as shown in FIG. 4, this disclosure enables the transmission of synchronization signal blocks (SSB) within the bandwidth of a designated frequency region, regardless of the mapping relationship between beam groups and subchannels. This may require modification of the existing one-to-one mapping relationship between beam groups and subchannels.

In one embodiment of this disclosure, all beam groups can sequentially transmit SSBs according to a predetermined order. During the SSB transmission period, permutation can be applied to the mapping relationship between beam groups and subchannels. The equation for applying permutation can be defined as Equation 1:

$${k}_{B G}^{itlv} = ( {k}_{B {G}_{n}} - S {C}_{b w} l ) mod {N}_{BG} \qquad [ Equation l ]$$

Here, k_{BG}_{ₙ} is the frequency subcarrier index of the nth beam group, l is the OFDM symbol index, SC_{bw} is the number of subcarriers corresponding to the basic bandwidth of a subchannel, and N_{BG} is the total number of beam groups.

During SSB burst periods in slots or frames, each beam group can apply the permutation method to transmit SSBs and data by moving them to match designated frequency band regions. In time periods when SSB is not being transmitted, data and reference signals such as DMRS and CSI-RS can be transmitted. Additionally, beam groups associated with subchannels not transmitting SSB signals can transmit data and reference signals.

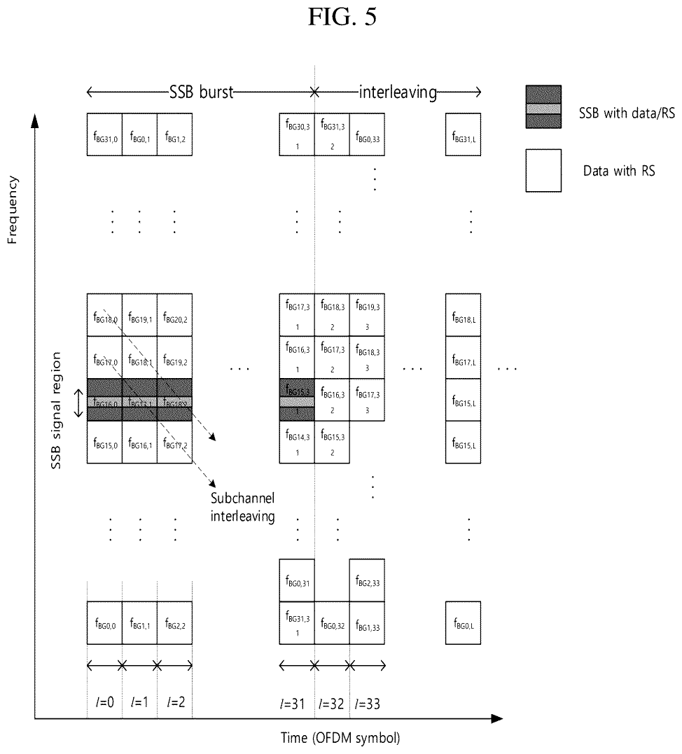

FIG. 5 illustrates a periodic permutation mapping structure between beam groups and subchannels according to an embodiment of the present disclosure.

In another embodiment of this disclosure, as shown in FIG. 5, the mapping relationship between beam groups and subchannels can be permuted at regular intervals not only during SSB burst periods but also throughout the entire slot and frame periods.

Additionally, in one embodiment of this disclosure, even when multiple beam groups are integrated into one beam group, it can be assumed that SSB transmission is performed sequentially by each basic unit beam group.

2b. Method for Uplink Signal Transmission Related to Group Beamforming for Terminal Initial Access

According to one embodiment of the present disclosure, this disclosure can provide a procedure for terminal initial access.

To access the base station, terminals decode the synchronization signal block (SSB) periodically transmitted by the base station and can acquire information about the associated downlink channel based on this. Particularly, in cases where directional transmission beamforming is repeatedly transmitted within a certain time period, as in 5G NR, terminals can transmit random access preambles corresponding to specific beam directions of the base station's synchronization signal through the Random Access CHannel (RACH).

In one embodiment of this disclosure, RACH signals can be transmitted through RACH occasions (RO), which are specific frequency or time resources designated by the base station. RO information can be acquired through system information (SI) in the physical broadcasting channel (PBCH) and remaining minimum system information (RMSI) in the physical downlink shared channel (PDSCH).

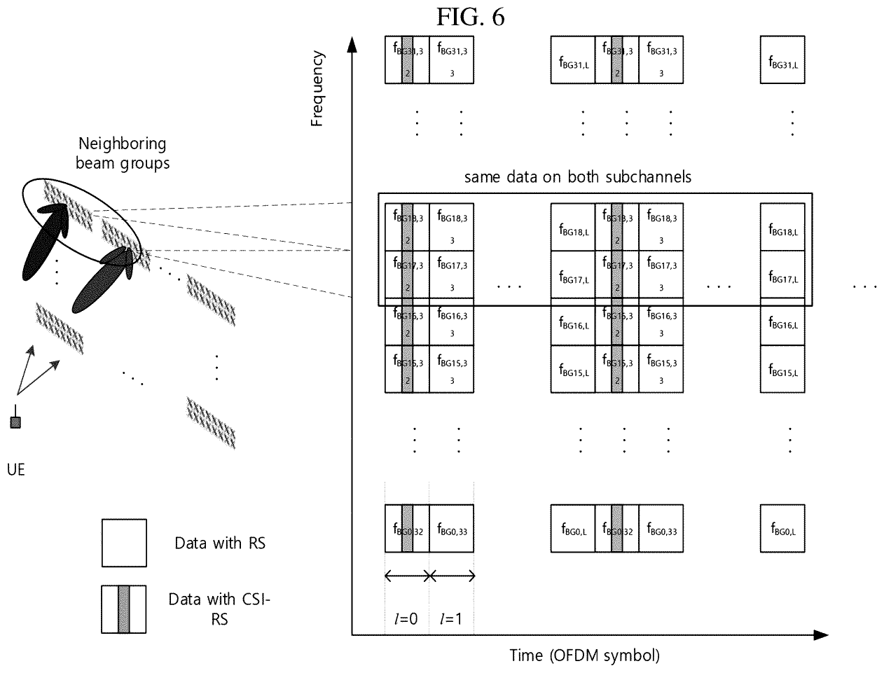

FIG. 6 illustrates a random access procedure for terminal initial access according to an embodiment of the present disclosure.

As shown in FIG. 6, terminal initial access can be performed through a four-step random access procedure:
(1) In the first step (preamble transmission), the terminal can randomly select one from a set of preambles defined by the base station and transmit it through PRACH.
(2) In the second step (random access response), the base station can transmit RAR containing timing advance information, RAPID, and uplink grant through PDSCH.
(3) In the third step (PUSCH transmission), the terminal can transmit RRC request messages and data through PUSCH.
(4) In the fourth step (contention resolution), the base station can transmit a message containing the terminal identifier through PDCCH and/or PDSCH.

In one embodiment of this disclosure, the terminal can derive the resource position of RO corresponding to SSB in the time domain using the PRACH configuration index. The mapping between RO and SSB can be determined through RRC parameters msg1-FDM and ssb-perRACH-OccationAndCB-PreamblesPerSSB.

Unlike conventional methods, this disclosure features terminals selecting beam groups during the beam sweeping process. Terminals can transmit PRACH either to RO in fixed common time or frequency domains, or to RO designated per subchannel. Additionally, the base station transmits RAR restricted to the time or frequency resources of the corresponding subchannel, and terminals can verify this information through MAC CE information transmitted per subchannel.

In one embodiment of this disclosure, the base station can transmit system information including at least one of time resource information, frequency resource information, and sequence resource information for PRACH. This system information can include at least one of MIB (Master Information Block) or SIB (System Information Block).

After PRACH transmission, terminals can perform monitoring for PDCCH reception. This PDCCH monitoring can be performed in time periods defined by search space and control resource set (CORESET). Specifically, terminals can perform monitoring for RAR (msg2) reception at monitoring occasions of slots belonging to the RAR window.

In one embodiment of this disclosure, the base station can transmit RAR through PDSCH, and terminals can verify whether the RAPID included in the received RAR matches the RAPID of their transmitted Msg1. If matching, terminals can proceed to the third step (Msg3), and if no matching RAPID is received within the RAR window, they can retransmit PRACH.

In distinctive implementations of this disclosure, all transmission direction sweeping within the SSB burst can be repeatedly transmitted per frame. Particularly, even in emMIMO systems with numerous beam groups, transmission beam sweeping can be configured to complete within a single SSB burst period. For example, in the previously described embodiment, up to 32 SSBs can be configured to be transmitted sequentially per beam group within the SSB burst.

This disclosure can have the following distinctions compared to conventional methods:
(1) Terminals select beam groups during the beam sweeping process
(2) Two options are provided for PRACH transmission:
   Transmission to RO corresponding to SSB transmission order in fixed common time/frequency domain
   Transmission to RO designated per subchannel
(3) Differences in Msg2 reception process:
   Base station restricts RAR transmission to time/frequency resources of the corresponding subchannel when detecting PRACH
   Terminals identify these transmission characteristics through MAC CE information transmitted per subchannel

Through these implementations, efficient initial access procedures and beam management can be possible.

### 3) Method for Reference Signal Transmission for Beam Tracking

According to one embodiment of this disclosure, this disclosure can provide a beam tracking method after initial access.

Even for terminals that have successfully completed initial access, the directionality of beams aligned with beam groups of specific subchannels may not exactly match, and beam alignment may be needed as terminals move. Additionally, beam refinement work may be required as the direction can differ from the bore sight even within a certain range in the connected beam group.

For this purpose, as shown in FIG. 6, in one embodiment of this disclosure, CSI-RS (Channel State Information-Reference Signal) reference signals including multiple ports within the beam group can be periodically transmitted. The CSI-RS signals transmitted by the base station can be transmitted by orthogonally spreading (Hadamard codeword) reference signals that map port numbers and beam directions one-to-one in the time or frequency axis. Through this, combinations of beams steered in specific directions within the beam group can be transmitted simultaneously, and terminals can report to the base station the port number of the CSI-RS with the strongest received signal strength.

In one embodiment of this disclosure, as shown in FIG. 5, when interleaving between subchannels or beam groups continues even outside the SSB burst period, the frequency position mapping between CSI-RS and subchannels can be changed accordingly.

In preparation for movement to adjacent beam groups, terminals can identify the strength of beams per port based on CSI-RS reference signal received power (RSRP) measurements and report this to the base station through measurement reports. The base station can provide terminals with CSI-RS time/frequency information for the primary beam group and adjacent beam groups, and can predict terminal movement paths through CSI-RS resource information and SSB transmission timing of adjacent beam groups.

In one embodiment of the present invention, when the base station determines that a terminal is in an intermediate position between beam groups in terms of space or power, it can achieve diversity gain by scheduling downlink data through two or more beam groups. When terminals receive data and CSI-RS through multiple subchannels, uplink ACK/NACK and CSI measurement reports may vary depending on whether uplink subchannels are structured. When applying subchannel structure considering inter-channel interference between beam groups in the uplink, reports to the base station can be transmitted through two or more beam groups.

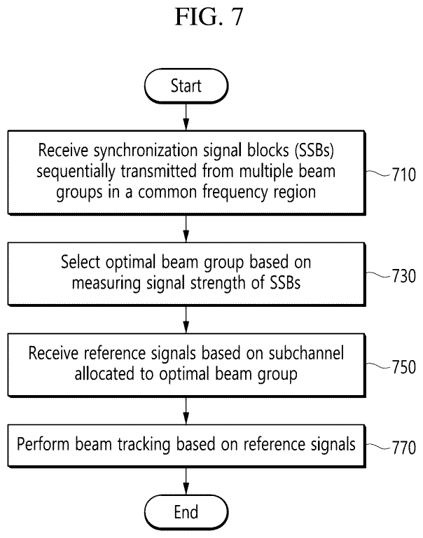

FIG. 7 illustrates a method of terminal operation according to an embodiment of the present disclosure.

Referring to FIG. 7, the terminal can receive synchronization signal blocks (SSB) sequentially transmitted from multiple beam groups in a common frequency region (710). In one embodiment of the present invention, this SSB reception can be a process where the terminal receives SSBs sequentially transmitted by the base station per beam group, as described earlier. According to one embodiment, the common frequency region is determined by the rotation of subchannels allocated to multiple beam groups, and the rotation of subchannels can be performed at predetermined time intervals. This can be implemented through an interleaving structure that is periodically performed throughout the entire slot and frame periods, as shown in FIG. 5.

The terminal can select the optimal beam group based on measuring the signal strength of the SSB (730). This selection process involves identifying the best beam group by comparing the signal quality of SSBs received from each beam group, and can be used to determine the optimal beam group considering the terminal's location and channel conditions.

The terminal can receive reference signals based on the subchannel allocated to the optimal beam group (750). The reference signals received through the subchannel of the selected beam group can serve as important reference signals for beam alignment and channel state measurement.

The terminal can include performing beam tracking based on the reference signals (770). According to one embodiment, the reference signal is CSI-RS (channel state information-reference signal), and CSI-RS can be transmitted through multiple orthogonally spread ports within the beam group. This enables efficient beam tracking as shown in FIG. 6.

According to one embodiment, the terminal can transmit a preamble through random access channel (RACH) resources corresponding to the optimal beam group. Additionally, the terminal can receive a random access response (RAR) through the subchannel allocated to the optimal beam group.

According to one embodiment, the terminal can receive CSI-RS resource information of adjacent beam groups and measure the reference signal received power (RSRP) of CSI-RS for adjacent beam groups. Furthermore, the terminal can report the RSRP to the base station. This process can play a crucial role in supporting terminal mobility and providing seamless service.

According to one embodiment, the terminal can simultaneously receive data through both the optimal beam group and one of the adjacent beam groups. This can improve communication reliability through diversity gain.

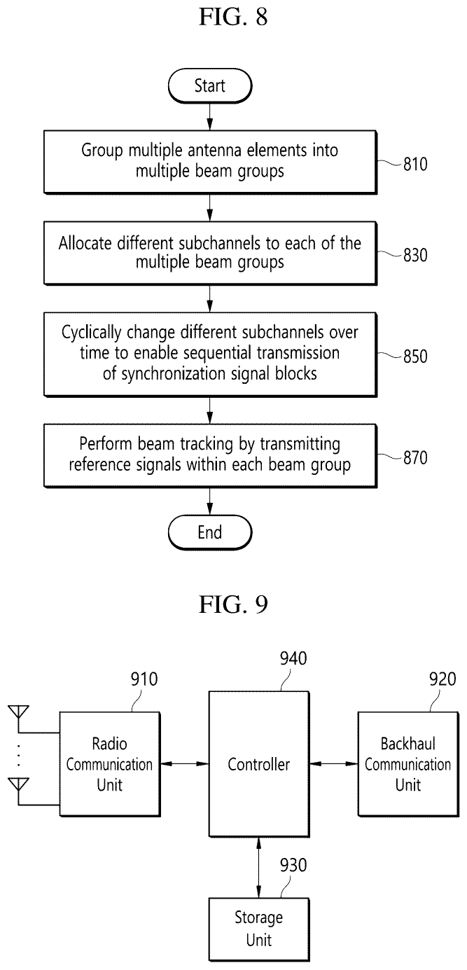

FIG. 8 illustrates a method of base station operation according to an embodiment of the present disclosure.

Referring to FIG. 8, the base station can group multiple antenna elements into multiple beam groups (810). As described earlier, this is a process of managing 1024 antenna elements by dividing them into multiple beam groups, where each beam group can be composed of physical components of adjacent antenna elements.

The base station can allocate different subchannels to each of the multiple beam groups (830). This allocation can be done uniformly or non-uniformly per beam group, and can efficiently divide and utilize the total system bandwidth. For example, when 32 beam groups are formed, the total downlink bandwidth of the system can be divided into 32 narrow bands.

The base station can cyclically change different subchannels over time to enable multiple beam groups to sequentially transmit synchronization signal blocks (SSB) in a common frequency region (850). According to one embodiment, the cyclic change of subchannels is performed at predetermined time intervals, and can minimize the power of beam groups not communicating with terminals. This cyclic change can be performed periodically throughout the entire slot and frame periods, as shown in FIG. 5.

The base station can perform beam tracking by transmitting reference signals within each beam group (870). According to one embodiment, the reference signal is CSI-RS (channel state information-reference signal), and CSI-RS can be transmitted through multiple orthogonally spread ports within each beam group. This enables efficient beam tracking as shown in FIG. 6.

According to one embodiment, the base station can identify the terminal's beam group based on the received preamble, and can transmit a random access response (RAR) through the subchannel allocated to the identified beam group. This plays a crucial role in the terminal's initial access process.

According to one embodiment, the base station can receive RSRP (reference signal received power) measurement reports for CSI-RS of adjacent beam groups from the terminal. These measurement reports can be utilized for terminal mobility management.

According to one embodiment, the base station can perform simultaneous transmission through two or more beam groups for the terminal based on the measurement reports. This can improve communication reliability through diversity gain.

As described above, this disclosure aims to:
(1) Present a method for forming beam groups that provides wide beam coverage while applying low-latency distributed beamforming to multiple terminals in an Extreme massive Multiple Input Multiple Output wireless communication environment,
(2) Present a method for allocating time/frequency resources without causing interference between beam groups by overcoming the challenges of desired beam formation when forming multiple terminals with distributed beamforming in co-channel situations during the same Orthogonal Frequency Division Multiplexing symbol time,
(3) Present methods for reference signal resource arrangement and beam management for multiple terminals' initial base station access in multi-beam group operation states, and
(4) Present methods for beam management to support terminal beam tracking and mobility.

According to the above-described disclosure, resource-efficient operation can be achieved by utilizing wide multiple beams in base stations with numerous antennas and implementing a structure without beam interference effects, aiming for high reliability and enabling low-latency parallel processing of connections and data transmission with multiple terminals. Additionally, power usage can be efficiently managed by minimizing power for beam groups that are not connecting or transmitting with terminals.

Additionally, the methods presented in this disclosure have the advantage of being readily adoptable in standards and relatively easy to implement from a practical perspective. Moreover, it can serve as an excellent component technology for next-generation wireless transmission.

FIG. 9 illustrates a configuration of a base station in a wireless communication system according to various embodiments of the present disclosure. The configuration illustrated in FIG. 9 can be understood as the configuration of a base station. The terms ‘ . . . unit’, ‘ . . . device’, etc. used hereinafter refer to units that process at least one function or operation, and these can be implemented in hardware, software, or a combination of hardware and software.

Referring to FIG. 9, the base station can include a wireless communication unit (910), a backhaul communication unit (920), a storage unit (930), and a control unit (940).

The wireless communication unit (910) can transmit and receive wireless signals through wireless channels. For example, the wireless communication unit (910) can perform conversion functions between baseband signals and bit sequences according to the physical layer specifications of the system. Additionally, the wireless communication unit (910) can generate complex symbols by encoding and modulating transmission bit sequences when transmitting data.

When receiving data, the wireless communication unit (910) can restore received bit sequences through demodulation and decoding of baseband signals.

The wireless communication unit (910) up-converts baseband signals to RF (radio frequency) band signals for transmission through antennas, and down-converts RF band signals received through antennas to baseband signals. For this purpose, the wireless communication unit (910) can include transmission filters, reception filters, amplifiers, mixers, oscillators, DAC (digital to analog converter), and ADC (analog to digital converter).

The wireless communication unit (910) can include multiple transmission and reception paths, and can include at least one antenna array composed of multiple antenna elements.

From a hardware perspective, the wireless communication unit (910) can include a digital unit and an analog unit, where the analog unit can include multiple sub-units depending on operating power, operating frequency, etc. The digital unit can be implemented with at least one processor (e.g., DSP (digital signal processor)).

The wireless communication unit (910) can transmit and receive wireless signals as described above. Accordingly, all or part of the wireless communication unit (910) can be referred to as a ‘transmitter’, ‘receiver’, or ‘transceiver’. Additionally, in the following description, transmission and reception through wireless channels can include processing performed by the wireless communication unit (910) as described above.

The backhaul communication unit (920) can provide an interface for communication with other nodes in the network. Specifically, the backhaul communication unit (920) can convert bit sequences transmitted from the base station to other nodes, such as other access nodes, other base stations, higher nodes, and core networks, into physical signals, and convert physical signals received from other nodes into bit sequences.

The storage unit (930) can store data such as basic programs, applications, and configuration information for base station operation. The storage unit (930) can be composed of volatile memory, non-volatile memory, or a combination of volatile and non-volatile memory. And, the storage unit (930) can provide stored data according to requests from the control unit (940).

The control unit (940) can control the overall operations of the base station. For example, the control unit (940) can transmit and receive signals through the wireless communication unit (910) or the backhaul communication unit (920). Additionally, the control unit (940) can write and read data to and from the storage unit (930). Also, the control unit (940) can perform functions of the protocol stack required by communication specifications.

For this purpose, the control unit (940) can include at least one processor.

According to various embodiments of the present disclosure, the control unit (940) can control the execution of various operations according to the various embodiments performed by the aforementioned base station.

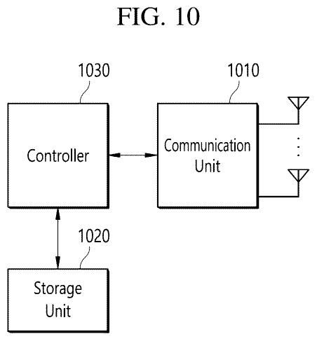

FIG. 10 illustrates a configuration of a terminal in a wireless communication system according to various embodiments of the present disclosure. The configuration illustrated in FIG. 10 can be understood as the configuration of a terminal. The terms ‘ . . . unit’, ‘ . . . device’, etc. used hereinafter refer to units that process at least one function or operation, and these can be implemented in hardware, software, or a combination of hardware and software.

Referring to FIG. 10, the terminal can include a communication unit (1010), a storage unit (1020), and a control unit (1030).

The communication unit (1010) can perform functions for transmitting and receiving signals through wireless channels. For example, the communication unit (1010) can perform conversion functions between baseband signals and bit sequences according to the physical layer specifications of the system. For example, when transmitting data, the communication unit (1010) can generate complex symbols by encoding and modulating transmission bit sequences. When receiving data, the communication unit (1010) can restore received bit sequences through demodulation and decoding of baseband signals. Additionally, the communication unit (1010) can up-convert baseband signals to RF band signals for transmission through antennas, and down-convert RF band signals received through antennas to baseband signals. For example, the communication unit (1010) can include transmission filters, reception filters, amplifiers, mixers, oscillators, DAC, ADC, etc.

Furthermore, the communication unit (1010) can include multiple transmission and reception paths. Moreover, the communication unit (1010) can include at least one antenna array composed of multiple antenna elements. From a hardware perspective, the communication unit (1010) can be composed of digital circuits and analog circuits (e.g., RFIC (radio frequency integrated circuit)). Here, the digital circuits and analog circuits can be implemented as a single package. Additionally, the communication unit (1010) can include multiple RF chains. Furthermore, the communication unit (1010) can perform beamforming.

The communication unit (1010) transmits and receives signals as described above. Accordingly, all or part of the communication unit (1010) can be referred to as a ‘transmitter’, ‘receiver’, or ‘transceiver’. Also, in the following description, transmission and reception through wireless channels can be used to include processing performed by the communication unit (1010) as described above.

The storage unit (1020) can store data such as basic programs, applications, and configuration information for terminal operation. The storage unit (1020) can be composed of volatile memory, non-volatile memory, or a combination of volatile and non-volatile memory. And, the storage unit (1020) can provide stored data according to requests from the control unit (1030).

The control unit (1030) can control the overall operations of the terminal. For example, the control unit (1030) can transmit and receive signals through the communication unit (1010). Additionally, the control unit (1030) can write and read data to and from the storage unit (1020). The control unit (1030) can perform functions of the protocol stack required by communication specifications. For this purpose, the control unit (1030) can include or be part of at least one processor or micro processor. Also, part of the communication unit (1010) and the control unit (1030) can be referred to as a CP (communication processor).

According to various embodiments, the control unit (1030) can control the execution of various operations according to the various embodiments performed by the aforementioned terminal.

The methods according to the embodiments described in the claims or specification of this disclosure can be implemented in the form of hardware, software, or a combination of hardware and software.

When implementing in software, a computer-readable storage medium storing one or more programs (software modules) can be provided. The one or more programs stored in the computer-readable storage medium are configured for execution by one or more processors within an electronic device. The one or more programs include instructions that cause the electronic device to execute methods according to the embodiments described in the claims or specification of this disclosure.

Such programs (software modules, software) can be stored in random access memory, non-volatile memory including flash memory, read only memory (ROM), electrically erasable programmable read only memory (EEPROM), magnetic disc storage devices, compact disc-ROM (CD-ROM), digital versatile discs (DVDs) or other forms of optical storage devices, magnetic cassettes. Alternatively, they can be stored in memory composed of combinations of some or all of these. Also, each constituent memory can include multiple units.

Additionally, programs can be stored in attachable storage devices that can be accessed through communication networks such as the Internet, Intranet, LAN (local area network), WAN (wide area network), or SAN (storage area network), or combinations thereof. Such storage devices can connect to devices performing embodiments of this disclosure through external ports. Also, separate storage devices on the communication network can connect to devices performing embodiments of this disclosure.

In the specific embodiments of this disclosure described above, components included in the disclosure were expressed in singular or plural according to the specific embodiments presented. However, the singular or plural expressions were chosen appropriately for convenience of description, and this disclosure is not limited to singular or plural components. Components expressed in plural can be configured in singular, and components expressed in singular can be configured in plural.

While the detailed description of this disclosure has explained specific embodiments, it is of course possible to make various modifications within limits that do not deviate from the scope of this disclosure. Therefore, the scope of this disclosure should not be limited to the described embodiments but should be determined by the following patent claims as well as equivalents to these patent claims.

What is claimed is:

1. A method for operating a terminal in a wireless communication system, comprising:
receiving a synchronization signal block (SSB) transmitted from multiple beam groups in a common frequency region;
selecting an optimal beam group based on measuring signal strength of the SSB;
receiving a reference signal based on a subchannel allocated to the optimal beam group; and performing beam tracking based on the reference signal.

2. The method of claim 1,
wherein the reference signal is a CSI-RS (channel state information-reference signal), and the CSI-RS is transmitted through multiple orthogonally spread ports within the beam group.

3. The method of claim 1, further comprising:
transmitting a preamble through random access channel (RACH) resources corresponding to the optimal beam group; and
receiving a random access response (RAR) through the subchannel allocated to the optimal beam group.

4. The method of claim 1, further comprising:
receiving CSI-RS resource information of adjacent beam groups; measuring RSRP (reference signal received power) for CSI-RS of the adjacent beam groups; reporting the RSRP to a base station; and
simultaneously receiving data through both the optimal beam group and one of the adjacent beam groups.

5. The method of claim 1,
wherein the common frequency region is determined according to rotation of subchannels allocated to the multiple beam groups, and the rotation of subchannels is performed at predetermined time intervals.

6. A terminal in a wireless communication system, comprising:
a transceiver; and a controller operably connected to the transceiver,
wherein the controller is configured to: receive a synchronization signal block (SSB) transmitted from multiple beam groups in a common frequency region;
select an optimal beam group based on measuring signal strength of the SSB;
receive a reference signal based on a subchannel allocated to the optimal beam group; and
perform beam tracking based on the reference signal.

7. The terminal of claim 6,
wherein the reference signal is a CSI-RS (channel state information-reference signal), and the CSI-RS is transmitted through multiple orthogonally spread ports within the beam group.

8. The terminal of claim 6,
wherein the controller is configured to: transmit a preamble through random access channel (RACH) resources corresponding to the optimal beam group; and
receive a random access response (RAR) through the subchannel allocated to the optimal beam group.

9. The terminal of claim 6,
wherein the controller is configured to: receive CSI-RS resource information of adjacent beam groups;
measure RSRP (reference signal received power) for CSI-RS of the adjacent beam groups; report the RSRP to a base station; and
simultaneously receive data through both the optimal beam group and one of the adjacent beam groups.

10. The terminal of claim 6,
wherein the common frequency region is determined according to rotation of subchannels allocated to the multiple beam groups, and the rotation of subchannels is performed at predetermined time intervals.

11. A method for operating a base station in a wireless communication system, comprising:
grouping multiple antenna elements into multiple beam groups; allocating different subchannels to each of the multiple beam groups;
cyclically changing the different subchannels over time to enable the multiple beam groups to transmit synchronization signal blocks (SSBs) in a common frequency region; and
performing beam tracking by transmitting reference signals within each beam group.

12. The method of claim 11, wherein the reference signal is a Channel State Information-Reference Signal (CSI-RS), and the CSI-RS is transmitted through multiple orthogonally spread ports within each beam group.

13. The method of claim 11, further comprising:
identifying a beam group of a terminal based on a preamble received from the terminal; and
transmitting a Random Access Response (RAR) through a subchannel allocated to the identified beam group.

14. The method of claim 11, further comprising:
receiving Reference Signal Received Power (RSRP) measurement reports for CSI-RS of adjacent beam groups from a terminal; and
performing simultaneous transmission through two or more beam groups for the terminal based on the measurement reports.

15. The method of claim 11,
wherein the subchannel cycling is performed at predetermined time intervals, and power is minimized for beam groups not communicating with terminals.

16. A base station in a wireless communication system, comprising:
a transceiver; and a controller operably connected to the transceiver,
wherein the controller is configured to: group multiple antenna elements into multiple beam groups;
allocate different subchannels to each of the multiple beam groups;
cyclically change the different subchannels over time to enable the multiple beam groups to transmit synchronization signal blocks (SSBs) in a common frequency region; and
perform beam tracking by transmitting reference signals within each beam group.

17. The base station of claim 16, wherein the reference signal is a Channel State Information-Reference Signal (CSI-RS), and the CSI-RS is transmitted through multiple orthogonally spread ports within each beam group.

18. The base station of claim 16, wherein the controller is configured to:
identify a beam group of a terminal based on a preamble received from the terminal; and
transmit a Random Access Response (RAR) through a subchannel allocated to the identified beam group.

19. The base station of claim 16, wherein the controller is configured to:
receive Reference Signal Received Power (RSRP) measurement reports for CSI-RS of adjacent beam groups from a terminal; and
perform simultaneous transmission through two or more beam groups for the terminal based on the measurement reports.

20. The base station of claim 16, wherein the subchannel cycling is performed at predetermined time intervals, and power is minimized for beam groups not communicating with terminals.
